(19) United States
(12) Patent Application Publication
(10) Pub. No.: US 2021/0297835 A1
(43) Pub. Date: Sep. 23, 2021

(54) SECURITY DEVICE WITH ALTERNATE COMMUNICATION CHANNEL

(71) Applicant: ARRIS Enterprises LLC, Suwanee, GA (US)

(72) Inventor: John D. OGDEN, Media, PA (US)

(21) Appl. No.: 17/177,386

(22) Filed: Feb. 17, 2021

Related U.S. Application Data
(60) Provisional application No. 62/993,196, filed on Mar. 23, 2020.

(51) Int. Cl. H04W 4/80; H04W 12/00; G08B 3/10; G08B 29/18

(52) U.S. Cl. CPC H04W 4/80; G08B 29/18; G08B 3/10; H04W 12/009

(57) ABSTRACT

A security device includes a processor, a sensor configured to detect unexpected activity, and a wireless network interface configured to connect to a remote server via Internet. If unexpected activity is detected and the wireless network interface can connect to the remote server via the Internet, the processor is configured to output an alert to the remote server via the Internet. If unexpected activity is detected and the wireless network interface cannot connect to the remote server via the Internet, the processor is configured to output the alert to the remote server via a radio configured to transmit independently of the Internet.

### BACKGROUND

Popular electronic apparatuses in many homes include security devices such as smart doorbells and smart cameras. These electronic apparatuses monitor areas inside or outside the homes so as to alert homeowners if unexpected activity is detected.

Existing solutions are Wi-Fi enabled and involve mounting a doorbell or camera to the exterior of a home. Therefore, if Internet connectivity is somehow interrupted or lost (for example, due to a power outage), then the existing solutions cannot alert the homeowner of the unexpected activity. In other words, the reliability of the existing solutions is entirely dependent on the presence and strength of Internet connectivity and the existing solutions can easily be compromised.

Thus, it would be advantageous and an improvement over existing solutions to provide a more robust security device with an alternate communication channel that maintains full or partial functionality even when Internet is interrupted or lost.

### SUMMARY

A security device is disclosed in the present application.

The security device comprises:

a processor;

a sensor configured to detect unexpected activity; and

a wireless network interface configured to connect to a remote server via Internet,

wherein, if the unexpected activity is detected, the processor is configured to output an alert to the remote server:

(i) via the Internet, if the wireless network interface can connect to the remote server via the Internet; and

(ii) via a radio configured to transmit independently of the Internet, if the wireless network interface cannot connect to the remote server via the Internet.

### BRIEF DESCRIPTION OF THE DRAWINGS

FIG. 1 shows a first exemplary implementation of a system including a security device 100, a gateway 200, a remote base station 300, a remote server 400 and an end user device 500 in a first condition in which the security device 100 cannot connect to the remote server 400 via the Internet.

FIG. 2 shows the first exemplary implementation of the system including the security device 100, the gateway 200, the remote base station 300, the remote server 400 and the end user device 500 in a second condition in which the security device 100 can connect to the remote server 400 via the Internet.

FIG. 3 shows a second exemplary implementation of a system including the security device 100, the gateway 200, the remote base station 300, the remote server 400, the end user device 500, and a backup battery 600.

FIG. 4 is a block diagram of one embodiment of the security device 100.

FIG. 5 is a sequence diagram illustrating exemplary operations of the security device 100, the gateway 200, the remote base station 300 and the remote server 400.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

The security device disclosed herein provides an alternate communication channel that maintains full or partial functionality even when Internet connectivity is interrupted or lost.

The security device disclosed herein addresses and solves the following problems:

How to reduce periods of impaired or no functionality of security devices.

How to enable long range communication in security devices independent of local area network access or wide area network access.

How to leverage the solution to the above-mentioned problems while using a low or efficient amount of power.

The security device disclosed herein solves the problems identified above and provides an efficient and cost effective solution for providing an alternate communication channel that maintains full or partial functionality even when Internet connectivity is interrupted or lost.

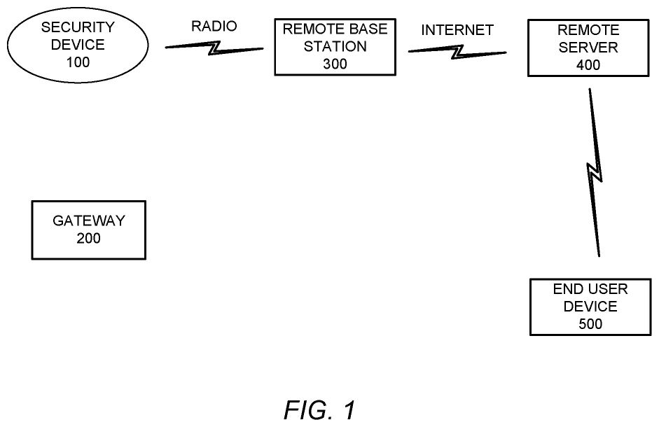

FIGS. 1-3 illustrate structural components implementing an electronic communication network. A gateway device 200, also referred to as a gateway, residential gateway, or RG, is an electronic device that is to be located so as to establish a local area network (LAN) at a consumer premises. The consumer premises can include a residential dwelling or business of a user. The terms home and premises may be used synonymously herein. The gateway 200 establishes, or is part of, a wireless local area network (WLAN), using Wi-Fi for example, such that the security device 100 is able to communicate wirelessly with the gateway 200. The term Wi-Fi as used herein may be considered to refer to any of Wi-Fi 4, 5, 6, 6E, or any variation thereof.

The gateway 200 communicates with a network server (not shown) which includes equipment such as server computers that enable an internet service provider to send/receive data either through physical media/wiring, such as a coaxial network, an optical fiber network, and/or DSL, or a wireless network, such as a satellite or terrestrial antenna implemented network or a combination of any of these examples or their equivalents. The data communicated on such network can be implemented using a variety of protocols on a network such as a wide area network (WAN), a virtual private network (VPN), metropolitan area networks (MANs), system area networks (SANs), a public switched telephone network (PTSA), a global Telex network, or a 2G, 3G, 4G or 5G network accessible via media. Such networks can also generally contextually be referred to herein as the Internet or the cloud.

The gateway 200 serves as a gateway or access point to the Internet (or otherwise as mentioned above) for the security device 100 that wirelessly communicates with the gateway 200 via, e.g., Wi-Fi. The security device 100 may be part of any electronic device, such as a security camera, smart doorbell, any other so called internet of things equipped device that is equipped to communicate information via the WLAN, or may be incorporated in another device or appliance and the scope of the present invention is not intended to be limited to such forms.

One or more Wi-Fi extenders (not shown) can be paired with the gateway 200 in order to communicate wirelessly with the gateway 200 and extend the coverage area of the WLAN. The security device 100 can be in communication with the gateway 200 or a Wi-Fi extender.

Within the WLAN, electronic devices are often referred to as being stations in the network. In IEEE 802.11 (Wi-Fi) terminology, a station (abbreviated as STA) is a device that has the capability to use the 802.11 protocol. For example, a station may be the security device 100, a laptop, a desktop PC, PDA, access point or Wi-Fi phone. An STA may be fixed, mobile or portable. Generally in wireless networking terminology, a station, wireless client, and node are often used interchangeably, with no strict distinction existing between these terms. A station may also be referred to as a transmitter or receiver based on its transmission characteristics. IEEE 802.11-2012 defines station as: A logical entity that is a singly addressable instance of a medium access control (MAC) and physical layer (PHY) interface to the wireless medium (WM).

A service set ID (SSID) is an identification (in IEEE 802.11) that is broadcast by access points in beacon packets to announce the presence of a network access point for the SSID. SSIDs are customizable IDs that can be zero to 32 bytes, and can be in a natural language, such as English.

The gateway 200 includes a controller, which can include a dedicated control circuit, CPU, microprocessor, etc. The controller controls the circuits of the gateway 200. Memory can store various programming, and user content, and data. The gateway 200 may also include an interface circuit, which can include one or more connectors, such as RF connectors, or Ethernet connectors, and/or wireless communication circuitry, such as 5G circuitry and one or more antennas. The interface circuit receives/transmits data to the remote server 400, by terrestrial antenna, satellite dish, wired cable, DSL, optical fibers, or 5G as discussed above. Through the interface circuit, the gateway 200 receives an input signal, including data, from the remote server 400 and can send data to the remote server.

The gateway 200 includes at least one radio, (and in some embodiments two or more radios), also referred to as a wireless communication circuit, such as a Wi-Fi WLAN interface radio transceiver for communication with the remote server 400, and any extenders. The at least one radio includes one or more antennas and communicates wirelessly via one or more of the 2.4 GHz band, the 5 GHz band, and the 6 GHz band, or at the appropriate band and bandwidth to implement the Wi-Fi 4, 5, 6, or 6E protocols. The gateway 200 can also be equipped with a radio to implement a Bluetooth interface radio transceiver and antenna, which communicates wirelessly in the ISM band, from 2.400 to 2.485 GHz. As an alternative, at least one of the radios can be a radio meeting a Radio Frequency For Consumer Electronics (RF4CE) protocol, ZigBee protocol, and/or IEEE 802.15.4 protocol, which also communicates in the ISM band. In some embodiments, at least one of the radios may be a long range (LoRa) radio or a Long-Term Evolution (LTE) radio, which will be explained in detail below.

The remote server 400 in FIG. 1 includes equipment such as server computers that enable a monitoring service, such as a security monitoring service, to receive alerts from the security device 100 through the Internet or the cloud. The server computers may also receive alerts from the security device 100 via the remote base station 300 through the Internet or the cloud.

FIG. 1 shows the first exemplary implementation of the system including the security device 100, the gateway 200, the remote base station 300, the remote server 400 and the end user device 500 in the first condition in which the security device 100 cannot connect to the remote server 400 via the Internet.

In the embodiment shown in FIGS. 1, 2 and 4, a radio 106 is embedded within the security device 100 itself. The radio 106 may be a LoRa radio or an LTE radio. A LoRa radio, for example, is a low-power wide-area network (LPWAN) technology. LoRa, for example, transmits over radio frequency bands such as 169 MHz, 433 MHz, 868 MHz and 915 MHz. LoRa provides a long range communication link with low power consumption. LoRaWAN is a specification for optimizing LPWANs. LoRaWAN network architecture includes remote base stations to relay messages between connected devices or end nodes and a network server.

The security device 100 can alternatively or additionally have a wireless data communication via a wireless network (e.g., 3G, LTE, 4G, 5G, etc.) with a mobile data provider.

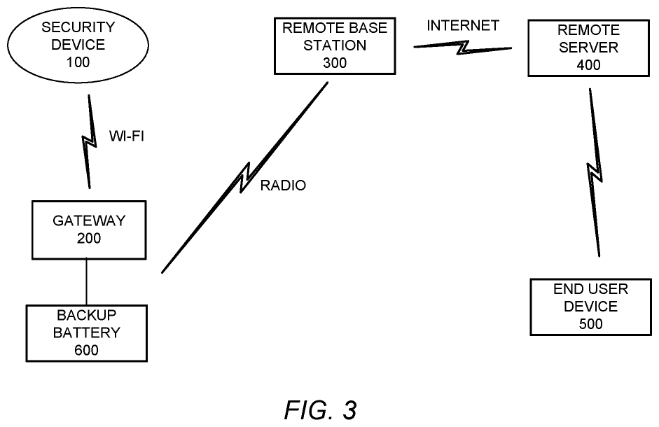

In some embodiments, the radio 106 may be omitted from the security device 100. In the embodiment shown in FIG. 3, a radio is included in the backup battery 600. Alternatively, the radio may be included in the gateway 200.

The remote base station 300 in FIG. 1 includes a concentrator or gateway which functions as an intermediary device to enable the security device 100 to transmit data to the Internet or cloud. The remote base station 300 is connected to the network server (not shown) and the remote server 400 via respective Internet Protocol (IP) links. The remote base station 300 is also connected to a power source (not shown). The remote base station 300 includes equipment to receive radio frequency (RF) packets from the radio 106 of the security device 100, convert the RF packets into IP packets, and send the IP packets to the remote server 400 via the Internet or cloud. The equipment may also receive IP packets from the remote server 400, convert the IP packets into RF packets, and send the RF packets to the radio 106 of the security device 100. The remote base station 300 may also include equipment for encrypting/decrypting messages or data transmitted therethrough. Accordingly, even if power to the gateway 200 is interrupted or lost, the radio 106 can still transmit to the remote base station 300 and vice versa.

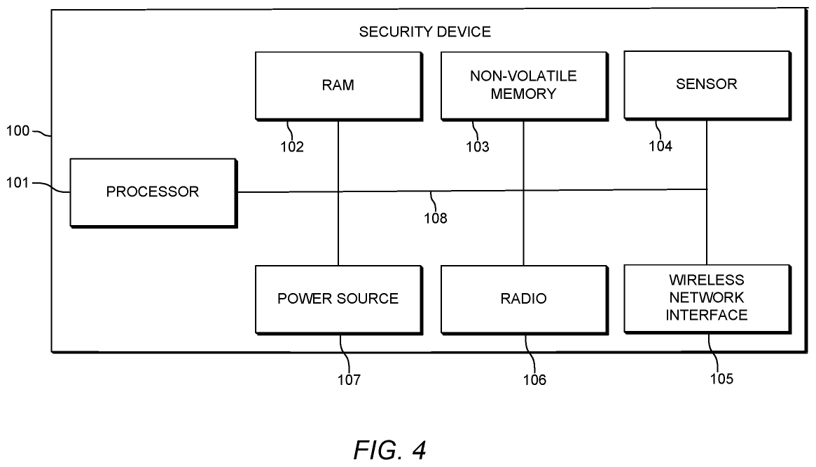

In the first condition shown in FIG. 1, the security device 100 cannot connect to the remote server 400 via the Internet (e.g., because the Wi-Fi or LAN connection between the security device 100 and the gateway 200 is interrupted or lost or because the WAN connection between the gateway 200 and the remote server 400 is interrupted or lost). The security device 100 includes a processor 101 and a sensor 104 configured to detect unexpected activity which will be described in further detail below with respect to FIG. 4. If unexpected activity is detected and the security device 100 cannot connect to the remote server 400 via the Internet (as in FIG. 1), the processor 101 is configured to output, by the radio 106, an alert to the remote server 400 via the remote base station 300. In other words, the security device 100 outputs the alert to the remote base station 300 via radio and the remote base station 300 converts and outputs the alert to the remote server 400 via the Internet. The remote server 400 may be operated, for example, by a third party security service. The remote server 400 may then output the alert to the end user device 500 such as a mobile telephone, laptop, tablet or smartwatch. The alert to the end user device 500 could be, for example, in the form of a short messaging service (SMS) message, an email message, or a push notification. A dedicated application for the security device 100 could be provided for the end user device 500 through which the end user or homeowner receives notifications.

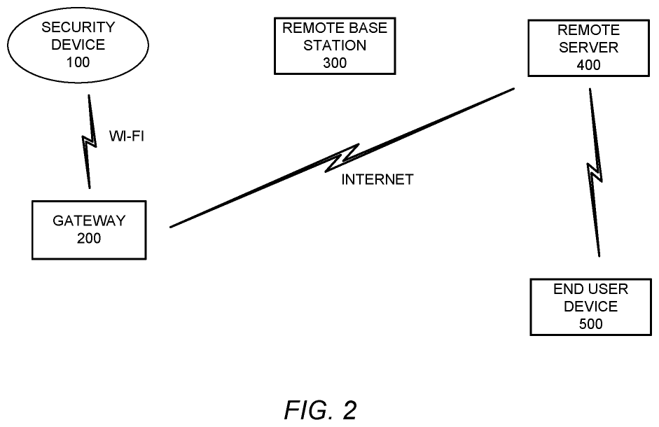

FIG. 2 shows the first exemplary implementation of the system including the security device 100, the gateway 200, the radio, 300, the remote server 400 and the end user device 500 in the second condition in which the security device 100 can connect to the remote server 400 via the Internet.

In the second condition shown in FIG. 2, the security device 100 has a Wi-Fi or LAN connection to the gateway 200 and the gateway has, for example, a WAN connection to the remote server 400. If unexpected activity is detected and the security device 100 can connect to the remote server 400 via the Internet (as in FIG. 2), the processor 101 is configured to output, by the wireless network interface 105 (see FIG. 4), an alert to the remote server 400 via the gateway 200. In other words, the security device 100 outputs the alert to the gateway 200 by the Wi-Fi or LAN connection and the gateway 200 outputs the alert to the remote server 400 by the WAN connection. As in FIG. 1, the remote server 400 may then output the alert to the end user device 500.

FIG. 3 shows the second exemplary implementation of the system including the security device 100, the gateway 200, the remote base station 300, the remote server 400, the end user device 500, and a backup battery 600. The backup battery 600 provides an auxiliary power source for the gateway 200. In the second embodiment shown in FIG. 3, a LoRa radio or an LTE radio is embedded within the backup battery 600. Alternatively, the LoRa radio or the LTE radio could be embedded within the gateway 200. In either case, the radio 106 may be omitted from the security device 100.

In the second embodiment shown in FIG. 3, the security device 100 cannot connect to the remote server 400 via the Internet (e.g., because the WAN connection between the gateway 200 and the remote server 400 is interrupted or lost). If unexpected activity is detected and the security device 100 cannot connect to the remote server 400 via the Internet (as in FIG. 3), the processor 101 is configured to output, by the wireless network interface 105, an alert to the remote server 400 via the gateway 200, the backup battery 600 and the remote base station 300. In other words, the security device 100 outputs the alert to the gateway 200 by the Wi-Fi or LAN connection, the gateway 200 outputs the alert to the backup battery 600, the backup battery 600 outputs the alert to the remote base station 300 by radio, and the remote base station 300 converts and outputs the alert to the remote server 400 by Internet. As in FIG. 1, the remote server 400 may then output the alert to the end user device 500.

In the second embodiment shown in FIG. 3, the backup battery 600 packages a backup communication system (e.g., a radio) together with a backup power source (e.g., a battery) and connects to the gateway 200 to provide both backup power and backup communication. Accordingly, the gateway 200 may be programmed to recognize alert messages or packets transmitted from the security device 100 and route them through the backup battery 600 when Internet WAN is unavailable. In embodiments not shown, the backup battery 600 could connect directly to the security device 100 to provide both backup power and backup communication. Accordingly, the security device 100 may be programmed to use the radio in the backup battery 600 when Internet connectivity is not available.

Communication between the backup battery 600 and the gateway 200 (or the security device 100 directly) could be any direct communication channel, either hard wired or wireless. For example, the backup battery 600 may be connected to the gateway 200 (or the security device 100 directly) by a wired communication connection such as a Universal Serial Bus (USB) or Ethernet cable. Alternatively, the backup battery 600 may be connected to the gateway 200 (or the security device 100 directly) by a wireless communication connection such as a Bluetooth or ZigBee connection.

In the alternative, the radio may included in the gateway 200 instead of the backup battery 600. If unexpected activity is detected and the security device 100 cannot connect to the remote server 400 via the Internet, the processor 101 is configured to output, by the wireless network interface 105, an alert to the remote server 400 via the gateway 200 and the remote base station 300. In other words, the security device 100 outputs the alert to the gateway 200 by the Wi-Fi or LAN connection, the gateway 200 outputs the alert to the remote base station 300 by radio, and the remote base station 300 converts and outputs the alert to the remote server 400 by Internet. In this alternative, the backup battery 600 simply provides an auxiliary power source for the gateway 200 and does not transmit the alert itself.

FIG. 4 is a block diagram of the security device 100. The security device 100 may include a processor 101, RAM 102, non-volatile memory 103, a sensor 104, a wireless network interface 105, a radio 106, a power source 107 and a communication bus 108 through which various components in the security device 100 are connected for communicating data therebetween.

The processor 101 may be a dedicated controller, CPU, microprocessor, etc., capable of controlling the operation of the components and circuits of the security device 100. The RAM 102 may be implemented as a working memory for the processor 101, and the non-volatile memory 103 can be provided for storage of program code, security data, image data, and other information. The sensor 104 may be, for example, a motion sensor, an infrared (IR) sensor or a camera. The camera may have machine vision capability providing automatic inspection and analysis of captured images. Alternatively or additionally, the sensor 104 may include a contact sensor installed at a door or window of a home or multiple contact sensors at multiple locations. The sensor 104 is configured to detect activity (expected or unexpected) inside or outside the home. The security device 100 can be programmed to differentiate between expected activity (e.g., visiting guests, delivery personnel, movement of pets inside the home, etc.) and unexpected activity. The security device 100 is configured to generate an alert to be sent to the homeowner if unexpected activity is detected. Unexpected activity could include, but is not limited to, any activity or motion when the homeowner is not present in the home, any activity or motion during certain time periods (such as nighttime), any activity or motion localized within a particular area of the home or property, or any activity or motion specially defined by the homeowner. For example, the unexpected activity could include motion detected by a camera such as trespassers moving on the property or unauthorized vehicles entering the driveway, and/or sounds detected by an audio sensor such as breaking glass or opening of a door or window. The wireless network interface 105 may include a Wi-Fi transceiver. In some embodiments, a radio 106 such as a LoRa radio or an LTE radio may be embedded within the security device 100 itself. In some variations, the radio 106 may be omitted from the security device 100. The power source 107 may be a battery, for example. The sensor 104 and/or wireless network interface 105 can enable the security device to be a so called smart security device, such as a smart doorbell device. Moreover, one or more of a Bluetooth transceiver, a user interface, a tuner, an IR receiver, far-field microphones (for e.g., voice command and/or presence recognition, and/or telephone communication), additional camera algorithms or additional cameras (for e.g., gesture recognition and/or video telephone communication), speakers, and associated programming may be included.

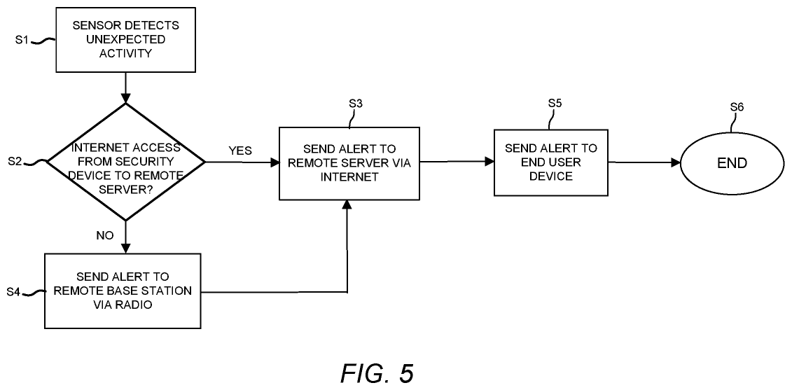

FIG. 5 is a sequence diagram illustrating exemplary operations of the security device 100, the gateway 200, the remote base station 300 and the remote server 400.

In Step S1, the sensor 104 detects unexpected activity.

In Step S2, it is determined whether the wireless network interface 105 can connect to the remote server 400 via the Internet.

If the wireless network interface 105 can connect to the remote server 400 via the Internet, in Step S3, the alert is sent to the remote server 400 via the Internet, as shown in FIG. 2.

If the wireless network interface 105 cannot connect to the remote server 400 via the Internet, in Step S4, the alert is sent to the remote base station 300 via radio, as shown in FIG. 1 or as shown in FIG. 3. The remote base station 300 then performs Step S3 and sends the alert to the remote server 400 via the Internet.

In Step S5, the alert is sent from the remote server 400 to the end user device 500.

In Step S6, the method ends.

The above may be implemented as any combination of an apparatus, a system, an integrated circuit, and a computer program on a non-transitory computer readable recording medium. The processor may be implemented as an integrated circuit (IC), an application specific integrated circuit (ASIC), or large scale integrated circuit (LSI), system LSI, super LSI, or ultra LSI components that perform a part or all of the functions described herein.

The processes disclosed above constitute algorithms that can be effected by software, applications (apps, or mobile apps), or computer programs. The software, applications, computer programs can be stored on a non-transitory computer-readable medium for causing a computer, such as the one or more processors, to execute the processes described herein and shown in the drawing figures.

The term non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The sequence of the steps included in the above described algorithms is exemplary, and algorithms having a sequence other than the above described sequences are contemplated. Moreover, steps, or parts of the algorithm, may be implemented simultaneously or in parallel.

The security device of the present invention can be in the form of a smart doorbell as in the exemplary embodiments disclosed above, or in other standalone devices, or may be incorporated in another device or appliance, and the scope of the present invention is not intended to be limited to such forms.

It is also contemplated that the implementation of the components of the present invention can be done with any newly arising technology that may replace any of the above implementation technologies.

The security device of the present invention can therefore provide long range reporting capability that can report security events when a Wi-Fi, LAN or WAN connection is unavailable. Accordingly, homeowners can still receive alerts even if Internet access to the security device is interrupted or lost.

We claim:

1. A security device comprising:
a processor;
a sensor configured to detect unexpected activity; and
a wireless network interface configured to connect to a remote server via Internet,
wherein, if the unexpected activity is detected, the processor is configured to output an alert to the remote server:
(i) via the Internet, if the wireless network interface can connect to the remote server via the Internet; and
(ii) via a radio configured to transmit independently of the Internet, if the wireless network interface cannot connect to the remote server via the Internet.

2. The security device of claim 1, wherein the radio is included in the security device.

3. The security device of claim 1, wherein the radio is a long range (LoRa) radio.

4. The security device of claim 1, wherein the radio is a Long-Term Evolution (LTE) radio.

5. The security device of claim 1, further comprising a power source.

6. The security device of claim 1, wherein the security device is a smart doorbell device.

7. A system comprising:
the security device of claim 1;
a gateway; and
a backup battery,
wherein:
the gateway is connected to the backup battery; and
the radio is included in one of the gateway and the backup battery.

8. The system of claim 7, wherein the radio is a LoRa radio.

9. The system of claim 7, wherein the radio is an LTE radio.

10. The system of claim 7, wherein the security device further comprises a power source.

11. The system of claim 7, wherein the security device is a smart doorbell device.

12. A method implemented on a security device, the method comprising:
if unexpected activity is detected by a sensor of the security device, outputting an alert to a remote server:
(i) via Internet, if a wireless network interface of the security device can connect to the remote server via the Internet; and
(ii) via a radio configured to transmit independently of the Internet, if the wireless network interface of the security device cannot connect to the remote server via the Internet.

13. The method of claim 12, further comprising outputting the alert to an end user device from the remote server.

14. The method of claim 12, wherein the radio is a long range (LoRa) radio.

15. The method of claim 12, wherein the radio is a Long-Term Evolution (LTE) radio.

16. The method of claim 12, wherein the security device is a smart doorbell device.

17. A non-transitory computer readable storage medium having stored thereon a program implemented on a security device, the program causing the security device to perform steps comprising:
if unexpected activity is detected by a sensor of the security device, outputting an alert to a remote server:
(i) via Internet, if a wireless network interface of the security device can connect to the remote server via the Internet; and
(ii) via a radio configured to transmit independently of the Internet, if the wireless network interface of the security device cannot connect to the remote server via the Internet.

18. The non-transitory computer readable storage medium of claim 15, wherein the radio is a long range (LoRa) radio.

19. The non-transitory computer readable storage medium of claim 15, wherein the radio is a Long-Term Evolution (LTE) radio.

20. The non-transitory computer readable storage medium of claim 15, wherein the security device is a smart doorbell device.
